(19) United States
(12) Patent Application Publication
(10) Pub. No.: US 2026/0332618 A1
(43) Pub. Date: Oct. 22, 2026

(54) DYNAMIC MULTI-LEVEL FRAMEWORK FOR EVENT-LEVEL ANOMALY DETECTION IN GRAPH-BASED SYSTEMS

(71) Applicant: Dell Products L.P., Round Rock, TX (US)

(72) Inventors: Shashank Kapoor, Uttar Pradesh (IN); Kailash Talreja, Maharashtra (IN); Saurabh Jha, Leander, TX (US)

(21) Appl. No.: 19/181,156

(22) Filed: Apr. 16, 2025

(51) Int. Cl. H04L 9/40

(52) U.S. Cl. CPC H04L 63/1425

(57) ABSTRACT

A method for responding to anomalies includes collecting a plurality of data logs on events in a distributed system. The method further includes processing the plurality of data logs into structured data. Moreover, the method includes transforming the structured data into a dynamic graph including a plurality of nodes. Each data log is a node, and a plurality of edges connects the plurality of nodes. Further, the method includes processing the dynamic graph to obtain hierarchical levels to form a hierarchical dynamic graph. Additionally, the method includes detecting a first anomaly in the first node of the hierarchical dynamic graph by evaluating a deviation from the first node with respect to the plurality of nodes. The method further includes formatting the first anomaly into a hierarchical visualization. Finally, the method includes converting the hierarchical visualization into actionable outputs.

### BACKGROUND

Anomalies in graph-based systems often represent critical events such as security breaches, system failures, or unexpected behaviors. Detecting and understanding these anomalies is essential for ensuring the reliability and safety of dynamic and distributed systems.

### BRIEF DESCRIPTION OF DRAWINGS

Certain embodiments disclosed herein will be described with reference to the accompanying drawings. However, the accompanying drawings illustrate only certain aspects or implementations of one or more embodiments disclosed herein by way of example and are not meant to limit the scope of the claims.

FIG. 1 shows a diagram of a distributed system connected to an anomaly detector in accordance with one or more embodiments disclosed herein.

FIG. 2 shows a flowchart for a method for responding to anomalies in accordance one or more embodiments disclosed herein.

FIG. 3.1 shows a table of structured data in accordance with one or more embodiments disclosed herein.

FIG. 3.2 shows a dynamic graph in accordance with one or more embodiments disclosed herein.

FIG. 3.3 shows a hierarchical dynamic graph in accordance with one or more embodiments disclosed herein.

FIG. 3.4 shows a visualization of anomalies on a graph in accordance with one or more embodiments disclosed herein.

FIG. 3.5 shows a hierarchical visualization of anomalies in accordance with one or more embodiments disclosed herein.

FIG. 4 shows a diagram of a computing device in accordance with one or more embodiments disclosed herein.

### DETAILED DESCRIPTION

Existing anomaly detection methods face two fundamental challenges, interpretability and scalability. Most current techniques detect anomalies but fail to provide clear, actionable explanations, especially in dynamic and complex graph structures. This lack of transparency hinders their applicability in high-stakes domains such as cybersecurity, industrial monitoring, and financial systems. For example, traditional methods often detect anomalies at a coarse level of granularity, such as across entire windows or global graph patterns. This lack of precision requires manual effort to identify specific events causing the anomaly. Without a hierarchical understanding of anomalies (local, regional, and global levels), users struggle to interpret results effectively. Further, traditional systems fail to provide actionable explanations, leaving users with black-box outputs that are difficult to trust or analyze. The absence of multi-level segmentation means users cannot gain insights across different abstraction levels of the graph. Interpreting critical events in dynamic and large-scale graph systems becomes a significant challenge. Additionally, most anomaly detection systems treat all parts of the graph equally, leading to wasted computational resources. High-impact regions or critical events are often overlooked due to the lack of focused attention mechanisms. This inefficiency reduces the accuracy and real-time applicability of detection systems. For at least the reasons discussed above, a different approach for detecting anomalies may be beneficial.

This disclosure introduces a dynamic multi-level framework that enhances explainability in event-level anomaly detection within graph-based systems. This disclosure leverages multi-level segmentation to provide hierarchical interpretability, allowing users to detect anomalies in software and hardware systems at local, regional, and global levels. By dynamically adapting to event granularity, the solution ensures precise anomaly localization and actionable insights. Anomalies are identified and explained at the level of individual events, providing precise localization compared to traditional window-based methods. To achieve robustness, the dynamic multi-level framework integrates segmentation-driven attention mechanisms that focus on critical regions of the graph, enabling efficient analysis of complex relationships in dynamic systems. The dynamic multi-level framework incorporates advanced visualization techniques, presenting anomalies through intuitive, multi-level representations that cater to both technical and non-technical users. Additionally, the solution is applicable to a multitude of domains, making it adaptable to diverse log sources and graph structures. This adaptability, coupled with real-time event detection and explainability, addresses critical challenges in scalability and interpretability for large-scale anomaly detection tasks.

The disclosure includes the following core components: segmentation-driven attention mechanisms, hierarchical visualization tools, integrated explanation and detection. The segmentation-driven attention mechanisms focus on critical regions within the graph, enabling efficient analysis of complex relationships and improving anomaly detection accuracy. Hierarchical visualization tools present anomalies intuitively, allowing users to explore event-level, subgraph-level, and system-wide patterns. Integrated explanation and detection integrate explainability directly into the anomaly detection pipeline. By combining these components, the disclosure prioritizes scalability, and real-time adaptability. This systematic approach not only enhances anomaly detection but also ensures that detected anomalies are accompanied by clear and actionable explanations, bridging the gap between detection and decision-making. The disclosure is designed to handle diverse types of graphs and logs, making it applicable to industries such as Internet of Things (IoT), finance, and cybersecurity.

The following describes various embodiments disclosed herein.

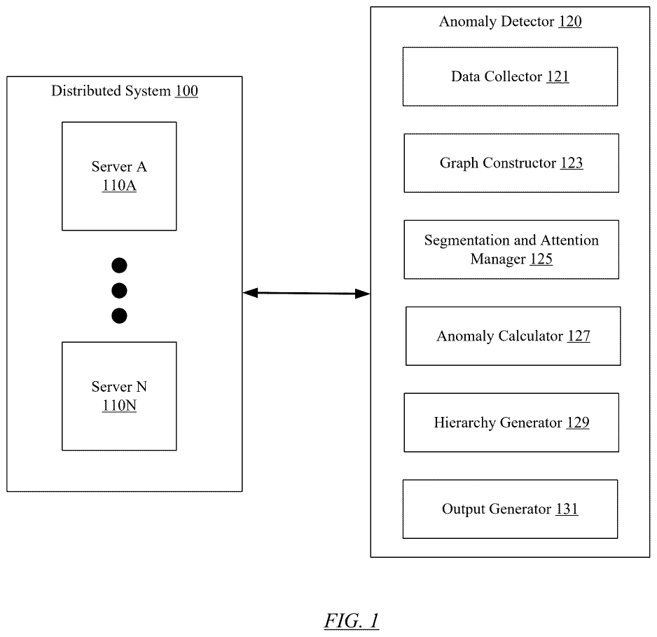

FIG. 1 shows a diagram of a distributed system (100) operatively connected to an anomaly detector (120) in accordance with one or more embodiments disclosed herein. Each of these components shown in FIG. 1 is described below.

The system may include additional, fewer, and/or different components without departing from the scope of the embodiments disclosed herein. Each component may be operably/operatively connected to any of the other components via any combination of wired and/or wireless connections (including connections to local area networks, wireless networks, and wide area networks). For example, the components shown in FIG. 1 may be connected via a network fabric (not shown). A network fabric refers to the interconnected topology and structure of network elements, e.g., switches, routers, and links, which work together to provide data transmission within between the components. The network fabric may be implemented using a spine-leaf topology, where every leaf switch connects to each spine switch. Those skilled in the art will appreciate that any other type of network (or network topology) may be used without departing from the disclosure.

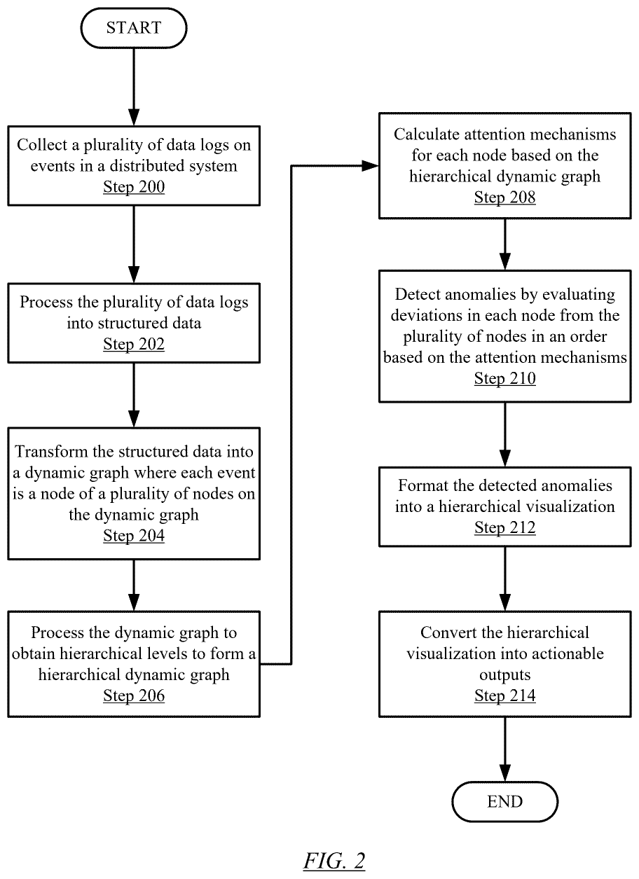

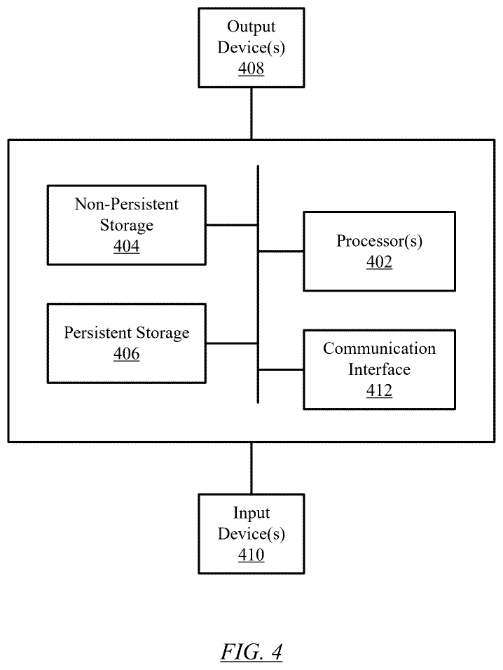

In one or more embodiments, the distributed system (100) may be, for example, an enterprise information technology system, an IoT system, or an enterprise storage system. The distributed system may include one or more of storage systems (not shown), networking hardware (not shown), and a plurality of servers (110A, 110N). The plurality of servers (110A, 110N) may include a server A (110A), a server N (110N), and any other number of servers. Besides servers, the distributed system (100) may include one or more computing devices (not shown) (see e.g., FIG. 4). The computing device(s) may be, for example, implemented as a distributed computing system, or a cloud resource. The computing device may include one or more processors, memory (e.g., random access memory), and persistent storage (e.g., disk drives, solid state drives, etc.). The computing device may provide the functionality of the distributed system (100) described throughout this application and/or all, or a portion thereof, of the method illustrated in FIG. 2.

In one or more embodiments, the distributed system (100) may include one or more logical devices (e.g., a virtual machine). Each logical device may utilize the computing resources of any number of computing devices and thereby provide the functionality of the distributed system (100) described throughout this application and/or all, or a portion thereof, of the method illustrated in FIG. 2.

In one or more embodiments, the distributed system (100) may include one or more applications (not shown) executing on a computing device(s) or a logical device(s). The applications may provide the functionality of the distributed system (100) described throughout this application and/or all, or a portion thereof, of the method illustrated in FIG. 2.

In one or more embodiments, the anomaly detector (120) is operatively connected to the distributed system (100) and includes functionality to detect and respond to anomalies in the distributed system (100) as shown in FIG. 2. The anomaly detector (120) includes a data collector (121), a graph constructor (123), a segmentation and attention manager (125), an anomaly calculator (127), a hierarchy generator (129), and an output generator (131). Each of these components is described below.

In one or more embodiments, the anomaly detector (120) may be implemented as one or more computing devices (see e.g., FIG. 4). The computing device(s) may be, for example, a server, a distributed computing system, or a cloud resource. The computing device may include one or more processors, memory (e.g., random access memory), and persistent storage (e.g., disk drives, solid state drives, etc.). The computing device may provide the functionality of the anomaly detector (120) described throughout this application and/or all, or a portion thereof, of the method illustrated in FIG. 2.

In one or more embodiments, the anomaly detector (120) may be implemented as a logical device(s) (e.g., a virtual machine). Each logical device may utilize the computing resources of any number of computing devices and thereby provide the functionality of the anomaly detector (120) described throughout this application and/or all, or a portion thereof, of the method illustrated in FIG. 2.

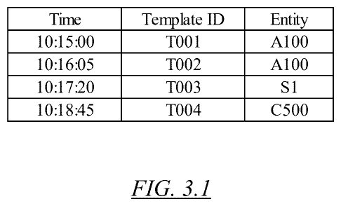

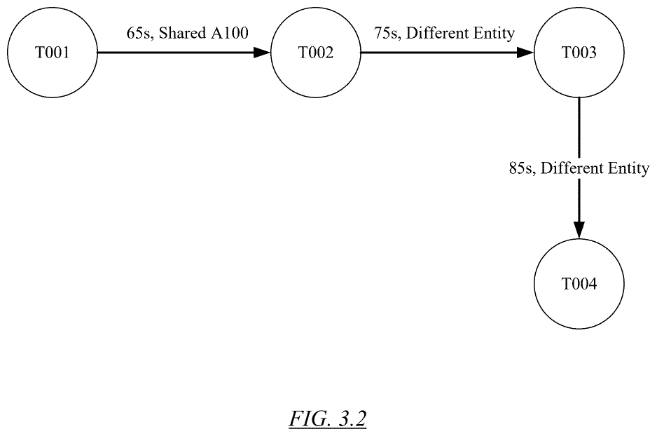

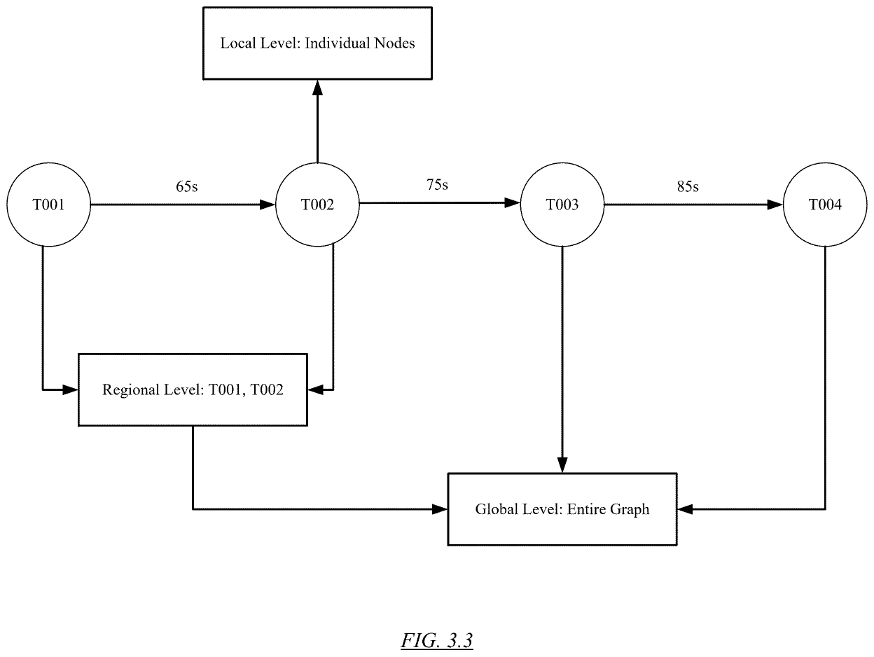

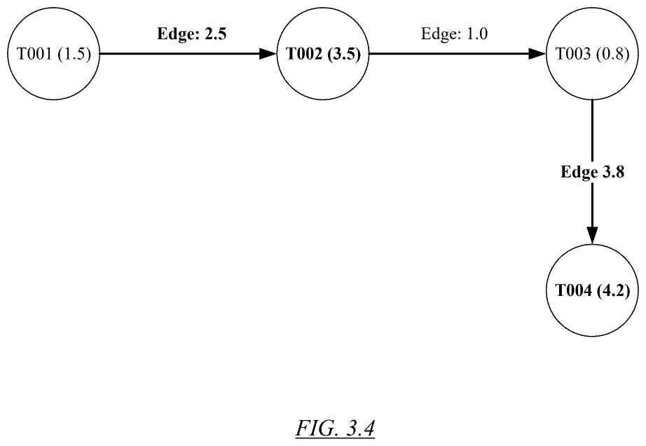

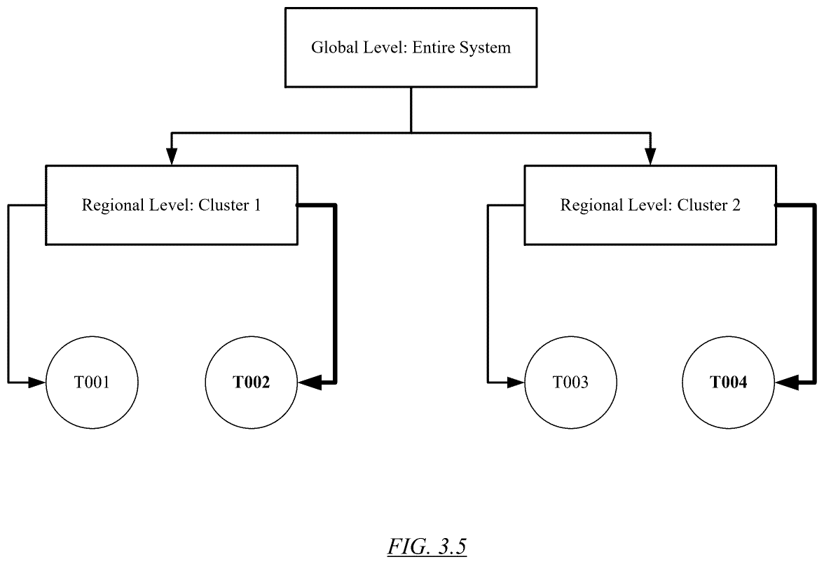

In one or more embodiments, the data collector (121) includes functionality to collect raw data logs from components of the distributed system (100). The data collector (121) further includes functionality to transform highly heterogeneous and unstructured data into a structured data format to form graphs. The structured data format is described in FIG. 3.1. In one or more embodiments, the graph constructor (123) includes functionality to transform data in the structured data format to a dynamic graph. The dynamic graph is described in FIG. 3.2.

In one or more embodiments, the segmentation and attention manager (125) includes functionality to divide the dynamic graph into hierarchical levels to form a hierarchical dynamic graph. The hierarchical dynamic graph is described in FIG. 3.3. The segmentation and attention manager (125) further includes functionality to apply attention mechanisms to portions of the hierarchical dynamic graph as described in FIG. 2. In one or more embodiments, the anomaly calculator (127) includes functionality to evaluate deviations in portions of the hierarchical dynamic graph to identify anomalies. The anomaly detector produces a visualization of anomalies on a graph that is described in FIG. 3.4.

In one or more embodiments, the hierarchy generator (129) includes functionality to create a display of detected anomalies in a hierarchical visualization. The hierarchical visualization of anomalies is described in FIG. 3.5. In one or more embodiments, the output generator (131) includes functionality to convert the hierarchical visualization into actionable outputs as described in FIG. 2. The output generator (131) may be connected to a graphical user interface (GUI) (not shown) to display the actionable outputs to a user. In one or more embodiments, the actionable outputs include automated responses to the anomalies and the output generator (131) further includes functionality to enact the automated responses.

Turning to FIG. 2, FIG. 2 shows a flowchart for a method for responding to anomalies in accordance one or more embodiments disclosed herein. The method of FIG. 2 may be performed by, for example, the anomaly detector (e.g., 120, FIG. 1). Other components of the system of FIG. 1 may perform all, or a portion, of the method of FIG. 2 without departing from the disclosure.

While the various steps in the flowchart of FIG. 2 are presented and described sequentially, one of ordinary skill in the relevant art will appreciate that some or all of the steps may be executed in different orders, may be combined, or omitted, and some or all steps may be executed in parallel.

In Step 200, the anomaly detector collects a plurality of data logs on events in a distributed system (e.g., 100, FIG. 1). The plurality of data logs are collected from the distributed system. The plurality of data logs are raw data logs from servers, storage systems, and networking hardware of the distributed system. The plurality of data logs may contain highly heterogeneous and unstructured data. For example, the raw data logs generated by an enterprise storage system may be as follows:
[2025-01-22 10:15:00] ALERT: Disk failure detected on storage array A100.
[2025-01-22 10:16:05] INFO: Disk rebuild started on storage array A100.
[2025-01-22 10:17:20] WARNING: Latency spike observed on server S1.
[2025-01-22 10:18:45] CRITICAL: Power supply failure on chassis C500.
   A first data log of the plurality of data logs may be the data log at [2025-01-22 10:15:00].

As shown above, the raw data logs may include a timestamp and a log description. The log description includes a log level (e.g., ALERT, INFO, WARNING, CRITICAL, etc.), a log type (e.g., disk failure detected), and an entity affected (e.g., storage array (“A”), server (“S”, chassis (“C”), etc.). The raw data logs pose challenges for anomaly detection and therefore are processed into a structured format. In one or more embodiments, a data collector (e.g., 121, FIG. 1) of the anomaly detector collects the plurality of data logs.

In Step 202, the anomaly detector processes the plurality of data logs into structured data. The plurality of data logs is processed to transform it into a structured format to be suitable for graph construction. In one or more embodiments, the data collector of the anomaly detector processes the plurality of data logs. First, the plurality of data logs are parsed for relevant fields (e.g., timestamp, log level, event type, and entity). The relevant fields are then extracted. After the relevant fields are extracted, the relevant fields are normalized. The timestamps (e.g., 2025-01-22 10:17:20) are converted into a standard format. The log levels are mapped to numerical values (e.g., ALERT=0, INFO=1, WARNING=2, CRITICAL=3). Finally, during a template encoding process, each of the log types are assigned unique template identifications (IDs) (e.g., with the numbering format T[number]). Returning to the example in Step 200, T001 is assigned to disk failure detected on entity A100 and T002 is assigned to disk rebuild started on entity A100. A log parse (e.g., drain) is used to identify and encode recurring templates in the plurality of data logs. After the plurality of data logs are processed into structured data, the structured data is stored in a tabular format as shown in FIG. 3.1. The structured data is stored in a database to enable efficient querying and transformation to form graphs. For example, the first data log includes a first time of 10:15:00, a first template ID of T001, and a first entity (e.g., first device) of A100.

In Step 204, the anomaly detector transforms the structured data into a dynamic graph. The dynamic graph has each event of the plurality of data logs be a node of a plurality of nodes. A node is connected to another node using an edge. The dynamic graph captures relationships between events and allows for advanced analysis of temporal and contextual patterns within the logs. To create the dynamic graphs, nodes are created for each event of the data logs based on the template ID from the structured logs. Continuing the example above, four nodes are created: a first node-T001: disk failure detected on A100, a second node-T002: disk rebuild started on A100, a third node-T003: latency spike observed on S2, and a fourth node-T004: power supply failure on C500.

After the nodes are created, edges are created to connect the plurality of nodes together. An edge between two nodes is based on (i) the temporal proximity of the nodes (e.g., the amount of time between the events) and (ii) whether the events are part of shared entities or separate entities (e.g., shared entity). The shared entity is a binary indicator: zero (i.e., false) if the two nodes do not share an entity and one (i.e., true) if the two nodes do share an entity. In one or more embodiments, the severity and context from the log level and event type of the data logs effect the edge (e.g., an absolute difference in log levels). Returning to the example in Step 202, the four nodes are connected by three edges: a first edge−(T001 to T002): [Time Interval=65 s, Severity Difference=2, Shared Entity=True], (T002 to T003): [Time Interval=75 s, Severity Difference=1, Shared Entity=False], and (T003 to T004): [Time Interval=85 s, Severity Difference=1, Shared Entity=False]. The dynamic graph may be stored in a graph database with the following schema:

```
{
  Template_ID: “T001”,
  Entity: Disk failure detected on A100,
  Edges: [ {
    Template_ID :”T002”,
    Time_interval: 65,
    Severity_Diff: 2,
    Shared_Entity:True} ]
}
```

In one or more embodiments, the graph constructor (e.g., 123, FIG. 1) of the anomaly detector transforms the structured data into the dynamic graph. An example of the dynamic graph is shown in FIG. 3.2.

In Step 206, the anomaly detector processes the dynamic graph to obtain hierarchical levels, which are used to form a hierarchical dynamic graph. The hierarchical dynamic graph includes the plurality of nodes from the dynamic graph set in hierarchical levels. The dynamic graph is divided into hierarchical levels (e.g., local level, regional level, and global level). The local level focuses on individual nodes and immediate neighbors of the individual nodes. For example, T001 is in a local level with T002. The regional level groups nodes into subgraphs based on shared entities or strong temporal relationships. For example, T001 and T002 are in a regional level based on sharing an entity (e.g., A100). The global level analyzes the entire graph to identify overall patterns and overarching trends. Returning to the example from Step 204, T002 is in a local level, T001 and T002 is in a regional level, and all four nodes are in a global level. In one or more embodiments, the segmentation and attention manager (e.g., 125, FIG. 1) of the anomaly detector processes the dynamic graph into the hierarchical dynamic graph. An example of the hierarchical dynamic graph is shown in FIG. 3.3.

In Step 208, the anomaly detector calculates attention mechanisms for each node of the plurality of nodes based on the hierarchical dynamic graph. The attention mechanisms prioritize critical regions of the hierarchical dynamic graph when detecting anomalies including critical nodes, critical edges, and critical subgraphs (e.g., regional and local level grouped nodes). The attention mechanisms prioritize the critical regions of the graph by assigning importance scores to the nodes and the edges. In one or more embodiments, for the edges, a raw attention score is calculated using the following equation.

eᵢⱼ=W·Concat(hᵢ,hⱼ,fᵢⱼ),

where hᵢ is a feature vector of node i, hⱼ is a feature vector of node j, and fᵢⱼ is a feature vector of the edge between node i and node j (e.g., factoring in time interval, severity difference). W is a learnable weight matrix and eᵢⱼ is the raw attention score of the edge between node i and node j. Concat( ) is a function for combining the string values of hᵢ, hⱼ, and fᵢⱼ. This value is multiplied by the learnable weight matrix, which may be set prior to the method, to calculate the raw attention score. In one or more embodiments, the normalized attention score is calculated using the raw attention score of the edge between node i and node j using the following equation.

$${α}_{ij} = \frac{exp ( {e}_{ij} )}{{\sum }_{k ∈ 𝒩 ( i )} \cdot exp ( {e}_{i k} )} ,$$

where N(i) is a set of all the neighbors of node i, eᵢₖ is the raw attention score between node i and the neighbor nodes, and αᵢⱼ is the normalized attention score between node i and node j. The exponential output of the raw attention score is divided by the product of the summation of the set of neighbors to node i and the exponential output of the raw attention score of node i and the neighbor nodes of node i to form the normalized attention score. In one or more embodiments, a first attention mechanism is calculated for the first node which prioritizes the first node over the other nodes.

For example, a normalized attention score is calculated for the first edge between the first node and the second node. The first node feature vector h_{T001} is equal to [3, Disk Failure] and the second node feature vector h_{T002} is equal to [1, Disk Rebuild]. The first edge feature vector f_{T001-T002} is equal to [65 (time interval), 2 (severity difference), 1 (shared entity)]. The values are input into the two equations above and a value of 0.72 is calculated. The second edge has a normalized attention value of 0.65. Therefore, the first edge has priority over the second edge.

The output of the attention mechanisms may include local (e.g., {T001→T002}, {T003→T004}), regional (e.g., Subgraph {T001, T002}, Subgraph {T003, T004}), and global (e.g., the full graph). In one or more embodiments, the segmentation and attention manager (e.g., 125, FIG. 1) calculates the attention mechanisms for each node, edge, and region.

In Step 210, the anomaly detector detects anomalies by evaluating deviations in each node from the plurality of nodes in an order based on the attention mechanisms. The focus is on using attention scores and link prediction models to determine whether specific events or relationships deviate from expected patterns. Each node and edge are evaluated for anomalies by comparing the associated feature vector and attention scores to learned thresholds or patterns. A node (vᵢ) is anomalous if the node's feature vector (hᵢ) deviates significantly from the expected distribution as shown in the equation below.

$${v}_{i} = \frac{‖ {h}_{i} - {μ}_{node} ‖}{{σ}_{node}} ,$$

where μ_{node} is the mean node feature vector set prior to the method and σ_{node} is the standard deviation of the mean node feature vector. If vᵢ is greater than a set threshold value, the node is anomalous.

An edge (cᵢⱼ) is anomalous if the edge's feature vector (fᵢⱼ) deviates significantly from the expected distribution as shown in the equation below.

$${c}_{ij} = \frac{‖ {f}_{ij} - {μ}_{edge} ‖}{{σ}_{edge}} ,$$

where μ_{edge} is the mean edge feature vector set prior to the method and σ_{edge} is the standard deviation of the mean edge feature vector. If eᵢⱼ is greater than a set threshold value, the edge is anomalous. For example, when the first edge feature vector, f_{T001-T002} is equal to [65 (time interval), 2 (severity diff), 1 (shared entity)], μ_{edge} is equal to [50,1,0.5], σ_{edge} is [10,0.5,0.2], an anomaly value can be calculated below.

$${e}_{T 001 - T 002} = \frac{‖ [ 65 , 2 , 1 ] - [ 50 , 1 , 0.5 ] ‖}{[ 10 , 0.5 , 0.2 ]} = \frac{\vert [ 15 , 1 , 0.5 ] ‖}{[ 10 , 0.5 , 0.2 ]} = [ 1.5 , 2 , 2.5 ]$$

Dimensionality reduction techniques, discussed below, are used to simplify the anomaly value to 2.5 which is greater than the set threshold value making the first edge anomalous.

In one or more embodiments, an edge may be discovered to be anomalous using link prediction. The link prediction model evaluates the likelihood, P(i→j), of the connection being normal as shown in the equation below.

$$P ( i \to j ) = σ ( {e}_{ij} ) , σ ( x ) = \frac{1}{1 + exp ( - x )} ,$$

where σ(x) is the sigmoid function and eᵢⱼ is the raw attention score of the edge. When the P(i→j) is below a set threshold value, the edge is anomalous.

Regions (e.g., subgraphs) of the hierarchical dynamic graph may have anomaly scores detected by combining node and edge anomaly scores in the regions as shown in the equation below.

$${subgraph}_{a n omaly} = \frac{{\sum }_{cij ∈ subgraph} {c}_{ij} + {\sum }_{V i ∈ s u b g raph} {v}_{i}}{\vert subgraph \vert} ,$$

where the summations of the anomaly scores of the nodes and edges are added together and divided by an absolute value of nodes and edges in the subgraph. Subgraphs where the anomaly score exceeds a set threshold value are anomalous. The subgraph may be the entire graph to determine if the global level is anomalous.

The output of the anomaly detection may include a textual report as shown below.

### Detected Anomalies:

Node: T001 (Disk failure detected on A100)
Reason: High deviation in severity level and shared entity activity.
Edge: (T001→T002)
Reason: Unusual time interval and severity difference.
Subgraph: {T001, T002}
Reason: Combined anomaly score above threshold value.
   In one or more embodiments, the anomaly calculator (e.g., 127, FIG. 1) of the anomaly detector calculates the anomaly scores for each node, edge, and region. An example visualization of anomalies on a graph is shown in FIG. 3.3.

For example, a first anomaly in the first node of the hierarchical dynamic graph is detected by evaluating a deviation from the first node of the hierarchical dynamic graph with respect to the plurality of nodes of the hierarchical dynamic graph. The first node of the hierarchical dynamic graph is evaluated first due to being prioritized by the first attention mechanism. The first anomaly indicates that the first node deviates significantly from an expected distribution of the plurality of nodes of the hierarchical dynamic graph.

In Step 212, the anomaly detector formats the detected anomalies into a hierarchical visualization. The hierarchical visualization provides insights at the local level, the regional level, and the global level and highlights critical nodes, edges, and regions. At the local level, the hierarchical visualization may highlight individual anomalous nodes and their direct neighbors. In one or more embodiments, saliency maps are used to show the importance of features contributing to the anomaly. At the regional level, the hierarchical visualization may visualize subgraphs containing multiple anomalies and may annotate edges and nodes with scores and explanations. At the global level, the hierarchical visualization may show the entire graph structure with trends and patterns and may provide a heatmap overlay indicating regions of high anomaly density.

To represent graphs in two-dimensional space, dimensionality reduction techniques may be used including t-distributed stochastic neighbor embedding which projects high-dimensional node embeddings to two dimensions and preserves neighborhood relationships, uniform manifold approximation and projection which maintains both local and global graph structure in reduced space, or a similar dimensionality reduction technique. The dimensionality reduction techniques may be used for calculating attention scores and anomaly scores.

For example, the hierarchical visualization may be formed using the following instructions. At the local level, highlight the first node (T001) due to the first anomaly (Disk failure) with severity deviation. At the regional level, display subgraph {T001, T002} with edge anomaly details (Anomaly Score: 3.5). At the global level, highlight the cluster (region) containing the first node (T001) and the second node (T002). In one or more embodiments, the hierarchy generator (e.g., 129, FIG. 1) of the anomaly detector creates the hierarchical visualization. The hierarchical visualization is shown in FIG. 3.3.

In Step 214, the anomaly detector converts the hierarchical visualization into actionable outputs. The actionable output may include one or more of a technical report, a managerial report, and an automated mitigation. The technical report includes detailed information on the anomalies with explanations and visualized subgraphs showing critical relationships. An example engineering report is shown below.
Node: T001 (Disk failure on A100)
Anomaly Score: 3.2
Reason: High severity deviation and entity activity.
Edge: (T001→T002)
Anomaly Score: 3.5
Reason: Unusual time interval (65 s)
shared entity: A100.
   In one or more embodiments, the output generator (e.g., 131, FIG. 1) of the anomaly detector may create the engineering report based on the hierarchical visualization. The engineering report may be displayed on the GUI to relevant stakeholders (e.g., engineer) by the output generator.

The managerial summary report includes high-level trends based on the first anomaly and other anomalies and actionable recommendations. An example managerial summary report is shown below.
Summary: Spike in disk failures on A100 on 22 Jan. 2025.
Risk Region: Subgraph {T001, T002}.
Recommendation: Prioritize disk health monitoring on A100.
   In one or more embodiments, the output generator may create the managerial summary report based on the hierarchical visualization. The managerial summary report may be displayed on the GUI to relevant stakeholders (e.g., managers) by the output generator.

The automated mitigation includes automatically triggering alerts or corrective actions for anomalies that are critical. To make an automated mitigation, first, a determination that an anomaly is a critical anomaly. Then, based on the determination the automated mitigation is triggered. An example of automatic mitigation is shown below.
Alert: Critical disk failure on A100 detected at 10:15 AM.
Action: Trigger backup process and notify admin team.
   In one or more embodiments, the output generator may perform the action on the distributed system based on the hierarchical visualization. The alert may be displayed on the GUI to relevant stakeholders by the output generator.

FIG. 3.1 shows an exemplary table of the structured data in accordance with one or more embodiments disclosed herein. The table includes three columns: time, template ID, and entity. The time is in a format Hour:Minute:Second (e.g., 10:18:45). The template ID is as described in Step 202 of FIG. 2. The template ID is an ID based on the log type for each event (e.g., T003, T004). The entity is the component of the distributed system where the event is directed (e.g., storage array A100, server S1, and chassis C500). In one or more embodiments, the table further includes a date, log level, and log type column. The table of the structured data is stored in a database to be used in the anomaly detection method as shown in FIG. 2. In one or more embodiments, the table may be displayed to users on the GUI.

FIG. 3.2 shows an exemplary dynamic graph in accordance with one or more embodiments disclosed herein. The dynamic graph includes nodes attached together by edges. The dynamic graph includes four nodes (e.g., a first node, T001, a second node, T002, a third node, T003, a fourth node, T004). The first node is connected to the second node with a first edge. The first edge includes a time duration of 65 s between the first node and the second node, and that the first node and the second node are on a shared entity, A100, based on information from the table of structured data. The second node is connected to the third node with a second edge. The second edge includes a time duration of 75 s between the second node and the third node and that the second node and the third node are on different entities based on information from the table of structured data. The third node is connected to the fourth node with a third edge. The third edge includes a time duration of 85 s between the third node and the fourth node and that the third node and the fourth node are on different entities based on information from the table of structured data. The dynamic graph is stored in a graph database to be used in the anomaly detection method as shown in FIG. 2. In one or more embodiments, the dynamic graph may be displayed to users on the GUI.

FIG. 3.3 shows an exemplary hierarchical dynamic graph in accordance with one or more embodiments disclosed herein. The hierarchical dynamic graph groups the nodes into hierarchical levels. The second node, T002, is in the local level as an individual node. The second node and the first node, T001, are in the regional level together due to sharing an entity. The first node, the second node, the third node, T003, and the fourth node, T004 are in the global level as they are all the nodes in the entire graph. The first edge, the second edge, and the third edge retain the time duration between nodes as shown in FIG. 3.2. In one or more embodiments, the hierarchical dynamic graph may be displayed to users on the GUI.

FIG. 3.4 shows an exemplary visualization of anomalies on a graph in accordance with one or more embodiments disclosed herein. The graph is similar to the dynamic graph shown in FIG. 3.2. Each node has its anomaly score embedded in the node. Each edge has its anomaly score embedded in the edge. If the anomaly score is greater than the set threshold value, the anomaly score is visually marked (e.g., bolded) to signify that the edge or the node is anomalous. In one or more embodiments, the visualization of anomalies may be displayed to users on the GUI.

FIG. 3.5 shows an exemplary hierarchical visualization of anomalies in accordance with one or more embodiments disclosed herein. The hierarchical visualization breaks the graph down into the global level, the regional levels, and the local levels (e.g., individual nodes). The second node, the fourth node, the first edge, and the fourth edge are bold to indicate the anomalies as shown in FIG. 3.4. In one or more embodiments, the hierarchical visualization may be displayed to users on the GUI.

As discussed above, embodiments of the disclosure may be implemented using computing devices. FIG. 4 shows a diagram of a computing device in accordance with one or more embodiments disclosed herein. The computing device may include one or more computer processor(s) (402), non-persistent storage (404) (e.g., volatile memory, such as RAM, cache memory), persistent storage (406) (e.g., a hard disk, an optical drive such as a compact disk (CD) drive or digital versatile disk (DVD) drive, a flash memory, etc.), a communication interface (412) (e.g., Bluetooth interface, infrared interface, network interface, optical interface, etc.), input devices (410), output devices (408), and numerous other elements (not shown) and functionalities. Each of these components is described below.

In one embodiment of the disclosure, the processor(s) (402) may be an integrated circuit for processing instructions. For example, the computer processor(s) may be one or more cores or micro-cores of a processor. The computing device may also include one or more input devices (410), such as a touchscreen, keyboard, mouse, microphone, touchpad, electronic pen, or any other type of input device. Further, the communication interface (412) may include an integrated circuit for connecting the computing device to a network (not shown) (e.g., a local area network (LAN), a wide area network (WAN) such as the Internet, mobile network, or any other type of network) and/or to another device, such as another computing device.

In one embodiment of the disclosure, the computing device may include one or more output devices (408), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (402), non-persistent storage (404), and persistent storage (406). Many different types of computing devices exist, and the aforementioned input and output device(s) may take other forms.

Software instructions in the form of computer readable program code to perform embodiments described herein may be stored, in whole or in part, temporarily or permanently, on a non-transitory computer readable medium such as a CD, DVD, storage device, a diskette, a tape, flash memory, physical memory, or any other physical computer readable storage medium. Specifically, the software instructions may correspond to computer readable program code that, when executed by a processor(s), is configured to enable the computer processor to perform one or more embodiments described herein.

The problems discussed above should be understood as being examples of problems solved by embodiments of the disclosure disclosed herein and the disclosure should not be limited only to solving the same/similar problems. The disclosure is broadly applicable to address a range of problems beyond those discussed herein.

Specific embodiments are described with reference to the accompanying figures. In the above description, numerous details are set forth as examples. It will be understood by those skilled in the art, that one or more embodiments of the present disclosure may be practiced without these specific details, and that numerous variations or modifications may be possible without departing from the scope. Certain details known to those of ordinary skill in the art are omitted to avoid obscuring the description.

In the prior description of the figures, any component described with regard to a figure, in various embodiments of the disclosure, may be equivalent to one or more like-named components described with regard to any other figure. For brevity, descriptions of these components are not repeated with regard to each figure. Thus, each and every embodiment of the components of each figure is incorporated by reference and assumed to be optionally present within every other figure having one or more like-named components. Additionally, in accordance with various embodiments of the disclosure, any description of the components of a figure is to be interpreted as an optional embodiment, which may be implemented in addition to, in conjunction with, or in place of the embodiments described with regard to a corresponding like-named component in any other figure.

Throughout this application, elements of figures may be labeled as A to N. As used herein, the aforementioned labeling means that the element may include any number of items and does not require that the element include the same number of elements as any other item labeled as A to N unless otherwise specified. For example, a data structure may include a first element labeled as A and a second element labeled as N. This labeling convention means that the data structure may include any number of the elements. A second data structure, also labeled as A to N, may also include any number of elements. The number of elements of the first data structure and the number of elements of the second data structure may be the same or different.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

As used herein, the phrase operatively connected, or operative connection, means that there exists between elements/components/devices a direct or indirect connection that allows the elements to interact with one another in some way. For example, the phrase ‘operatively connected’ may refer to any direct (e.g., wired directly between two devices or components) or indirect (e.g., wired and/or wireless connections between any number of devices or components connecting the operatively connected devices) connection. Thus, any path through which information may travel may be considered an operative connection.

Software instructions in the form of computer readable program code to perform embodiments described herein may be stored, in whole or in part, temporarily or permanently, on a non-transitory computer readable medium such as a CD, DVD, storage device, a diskette, a tape, flash memory, physical memory, or any other physical computer readable storage medium. Specifically, the software instructions may correspond to computer readable program code that, when executed by a processor(s), is configured to perform one or more embodiments described herein.

While the disclosure has been described above with respect to a limited number of embodiments, those skilled in the art, having the benefit of this disclosure, will appreciate that other embodiments can be devised which do not depart from the scope as disclosed herein. Accordingly, the scope of the disclosure should be limited only by the attached claims.

What is claimed is:

1. A method for responding to anomalies, comprising:
collecting a plurality of data logs on events in a distributed system, wherein the plurality of data logs comprises a first data log;
processing the plurality of data logs into structured data, wherein the structured data comprises a table comprising a first time of the first data log, a first template ID that describes the first data log, and a first device associated with the first data log;
transforming the structured data into a dynamic graph comprising a plurality of nodes, wherein:
each data log of the plurality of data logs is a node of the plurality of nodes,
a first node of the plurality of nodes represents the first template ID of the first data log, and
a plurality of edges connects the plurality of nodes;
processing the dynamic graph to obtain hierarchical levels to form a hierarchical dynamic graph comprising the plurality of nodes;
calculating a first attention mechanism for the first node based on the hierarchical dynamic graph, wherein an attention mechanism prioritizes critical regions of the hierarchical dynamic graph, and wherein the first node of the hierarchical dynamic graph is prioritized;
detecting, after calculating the first attention mechanism, a first anomaly in the first node of the hierarchical dynamic graph by evaluating a deviation from the first node of the hierarchical dynamic graph with respect to the plurality of nodes of the hierarchical dynamic graph, wherein the first node of the hierarchical dynamic graph is evaluated first due to being prioritized;
formatting the first anomaly of the first node into a hierarchical visualization; and
converting the hierarchical visualization into actionable outputs.

2. The method of claim 1, wherein a first edge of the plurality of edges comprises a time difference between the first node of the dynamic graph and a second node, wherein the second node is one of the plurality of nodes of the dynamic graph.

3. The method of claim 2, wherein the first edge reflects that the first node of the dynamic graph represents the first data log for the first device and the second node of the dynamic graph represents a second data log for a second device.

4. The method of claim 1, wherein the hierarchical levels comprise a local level, a regional level, and a global level.

5. The method of claim 1, wherein the actionable outputs comprise a technical report comprising detailed information on the first anomaly with explanations and visualized subgraphs showing critical relationships.

6. The method of claim 1, wherein the actionable outputs comprise a managerial summary report comprising high-level trends based on the first anomaly and other anomalies and actionable recommendations.

7. The method of claim 1, further comprising:
making a first determination based on the actionable outputs that the first anomaly is a critical anomaly; and
triggering, based on the first determination an automated mitigation based on the first anomaly.

8. The method of claim 1, wherein the first anomaly indicates that the first node deviates significantly from an expected distribution of the plurality of nodes of the hierarchical dynamic graph.

9. A non-transitory computer readable medium (CRM) comprising computer readable program code, which when executed by a computer processor enables the computer processor to perform a method for responding to anomalies, the method comprising:
collecting a plurality of data logs on events in a distributed system, wherein the plurality of data logs comprises a first data log;
processing the plurality of data logs into structured data, wherein the structured data comprises a table comprising a first time of the first data log, a first template ID that describes the first data log, and a first device associated with the first data log;
transforming the structured data into a dynamic graph comprising a plurality of nodes, wherein:
each data log of the plurality of data logs is a node of the plurality of nodes,
a first node of the plurality of nodes represents the first template ID of the first data log, and
a plurality of edges connects the plurality of nodes;
processing the dynamic graph to obtain hierarchical levels to form a hierarchical dynamic graph comprising the plurality of nodes;
calculating a first attention mechanism for the first node based on the hierarchical dynamic graph, wherein an attention mechanism prioritizes critical regions of the hierarchical dynamic graph, and wherein the first node of the hierarchical dynamic graph is prioritized;
detecting, after calculating the first attention mechanism, a first anomaly in the first node of the hierarchical dynamic graph by evaluating a deviation from the first node of the hierarchical dynamic graph with respect to the plurality of nodes of the hierarchical dynamic graph, wherein the first node of the hierarchical dynamic graph is evaluated first due to being prioritized;
formatting the first anomaly of the first node into a hierarchical visualization; and
converting the hierarchical visualization into actionable outputs.

10. The non-transitory CRM of claim 9, wherein a first edge of the plurality of edges comprises a time difference between the first node of the dynamic graph and a second node, wherein the second node is one of the plurality of nodes of the dynamic graph.

11. The non-transitory CRM of claim 10, wherein the first edge reflects that the first node of the dynamic graph represents the first data log for the first device and the second node of the dynamic graph represents a second data log for a second device.

12. The non-transitory CRM of claim 9, wherein the hierarchical levels comprise a local level, a regional level, and a global level.

13. The non-transitory CRM of claim 9, wherein the actionable outputs comprise a technical report comprising detailed information on the first anomaly with explanations and visualized subgraphs showing critical relationships.

14. The non-transitory CRM of claim 9, wherein the actionable outputs comprise a managerial summary report comprising high-level trends based on the first anomaly and other anomalies and actionable recommendations.

15. The non-transitory CRM of claim 9, further comprising:
making a first determination based on the actionable outputs that the first anomaly is a critical anomaly; and
triggering, based on the first determination an automated mitigation based on the first anomaly.

16. The non-transitory CRM of claim 9, wherein the first anomaly indicates that the first node deviates significantly from an expected distribution of the plurality of nodes of the hierarchical dynamic graph.

17. A system comprising:
a processor;
storage comprising instructions, which when executed by the processor perform a method for responding to anomalies, the method comprising:
collecting a plurality of data logs on events in a distributed system, wherein the plurality of data logs comprises a first data log;
processing the plurality of data logs into structured data, wherein the structured data comprises a table comprising a first time of the first data log, a first template ID that describes the first data log, and a first device associated with the first data log;
transforming the structured data into a dynamic graph comprising a plurality of nodes, wherein:
each data log of the plurality of data logs is a node of the plurality of nodes,
a first node of the plurality of nodes represents the first template ID of the first data log, and
a plurality of edges connects the plurality of nodes;
processing the dynamic graph to obtain hierarchical levels to form a hierarchical dynamic graph comprising the plurality of nodes;
calculating a first attention mechanism for the first node based on the hierarchical dynamic graph, wherein an attention mechanism prioritizes critical regions of the hierarchical dynamic graph, and wherein the first node of the hierarchical dynamic graph is prioritized;
detecting, after calculating the first attention mechanism, a first anomaly in the first node of the hierarchical dynamic graph by evaluating a deviation from the first node of the hierarchical dynamic graph with respect to the plurality of nodes of the hierarchical dynamic graph, wherein the first node of the hierarchical dynamic graph is evaluated first due to being prioritized;
formatting the first anomaly of the first node into a hierarchical visualization; and
converting the hierarchical visualization into actionable outputs.

18. The system of claim 17, wherein the actionable outputs comprise a technical report comprising detailed information on the first anomaly with explanations and visualized subgraphs showing critical relationships.

19. The system of claim 17, wherein the actionable outputs comprise a managerial summary report comprising high-level trends based on the first anomaly and other anomalies and actionable recommendations.

20. The system of claim 17, further comprising:
making a first determination based on the actionable outputs that the first anomaly is a critical anomaly; and
triggering, based on the first determination an automated mitigation based on the first anomaly.
